(19) United States
(12) Patent Application Publication
(10) Pub. No.: US 2011/0298821 A1
(43) Pub. Date: Dec. 8, 2011

(54) ELECTRONIC DEVICE AND METHOD OF DISPLAYING IMAGES

(75) Inventors: TENG-YU TSAI, Tu-Cheng (TW); CHIA-HUNG CHIEN, Tu-Cheng (TW); LIANG-MAO HUNG, Tu-Cheng (TW); CHIA-CHEN WU, Tu-Cheng (TW); CHI-FAN HO, Tu-Cheng (TW)

(73) Assignee: HON HAI PRECISION INDUSTRY CO., LTD., Tu-Cheng (TW)

(21) Appl. No.: 12/947,732

(22) Filed: Nov. 16, 2010

(30) Foreign Application Priority Data
Jun. 8, 2010 (CN) 201010194933.0

(51) Int. Cl. G09G 5/00

(52) U.S. Cl. 345/620

(57) ABSTRACT

A method of displaying images on an electronic device includes the following blocks. A first image is displayed on a display. The first image has a first edge and a second edge opposite to the first edge. A second image is decoded and loaded to a virtual position behind the first image. The first image is divided into a plurality of rectangular areas. The first image is cropped in the plurality of rectangular areas in sequence along a direction from the first edge to the second edge. Each of the plurality of rectangular areas fades to transparency. The second image is shown on the display.

### BACKGROUND

1. Technical Field

The present disclosure relates to electronic devices, and particularly to a method of using special effects when transitioning from one image to another on an electronic device display.

2. Description of Related Art

Electronic devices (such as digital photo frames) typically allow image browsing by touching the display or with a remote control. Images are stored in a flash storage of the electronic device. The electronic device decodes the images and stores the images in a buffer memory for display. When the user switches the displayed image, the displayed image may immediately disappear and the next image immediately be displayed on the screen. However, the immediate transition from one image to another is uninteresting for the user.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an electronic device in accordance with an embodiment.

FIG. 2 to FIG. 5 illustrate a transition process from a first image to a second image in an electronic device in one embodiment.

FIG. 3 is a flowchart of a method of switching images in the electronic device in one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

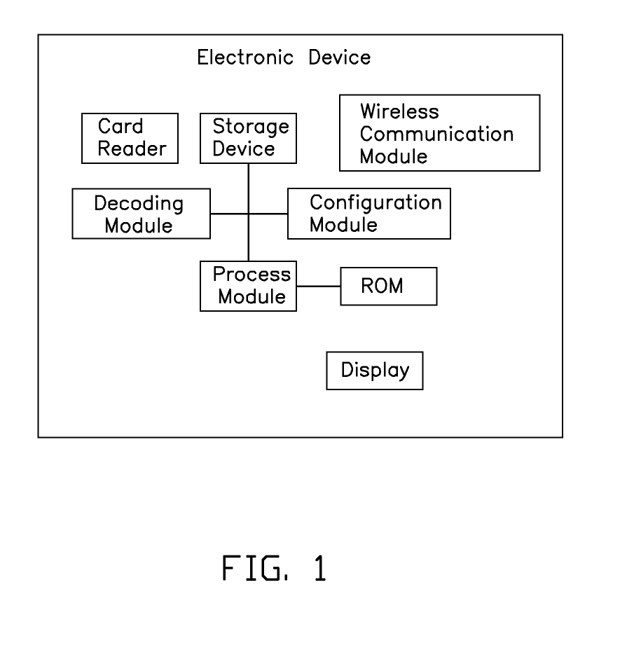

Referring to FIG. 1, in one embodiment, an electronic device may include a storage device, a card reader, a wireless communication module, a ROM, a decoding module, a configuration module, a process module, and a display.

The electronic device may be an embedded electronic device, such as a digital photo frame, a media player, or a mobile phone. The electronic device can employ special effects in transitioning from a first image to a second image on the display.

The storage device may store a plurality of images.

The card reader may be connected to the storage device. The card reader can directly read a storage card, such as Secure Digital (SD) card, Multi-Media (MMC) card, Compact Flash (CF), etc.

The wireless communication module is connected to the storage device. The storage device can receive the images through the wireless communication module.

In one embodiment, the display may include a touch screen. The touch screen is an electronic visual display that can detect the presence and location of a touch within the display area. The touch screen can recognize a point operation or a slide operation performed with a finger or a stylus.

The decoding module can decode the second image before the second image is displayed. The decoding module may take time to decode the second image. To save time, the decoding module may decode the second image while the first image is displayed. The second image is loaded to a virtual position behind the first image. Therefore, the first image in effect blocks or hides the second image while the display displays the first image. If we understand the images to be layers on the display and the first image is the top layer, then we can say the second image is a layer beneath the first image.

The first image has a first edge and a second edge opposite to the first edge. The process module can divide the first image into a plurality of rectangular areas. The process module can, for example, crop the rectangular areas in sequence along a direction from the first edge to the second edge. There rectangular areas may all be of the same size. In other embodiments, all but one of the plurality of rectangular areas may have the same size.

The cropping process of the first image will result in exposing the second image loaded behind it. The cropping process can be done slowly or quickly and involve further effects such as fading to transparency each rectangular area in sequence with or without overlapping in time of the fading of adjacent rectangular areas. One example of a special effect in detail follows.

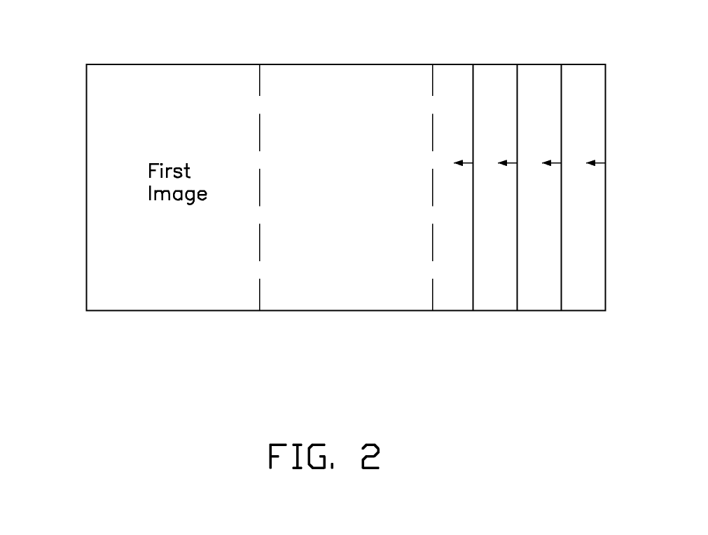

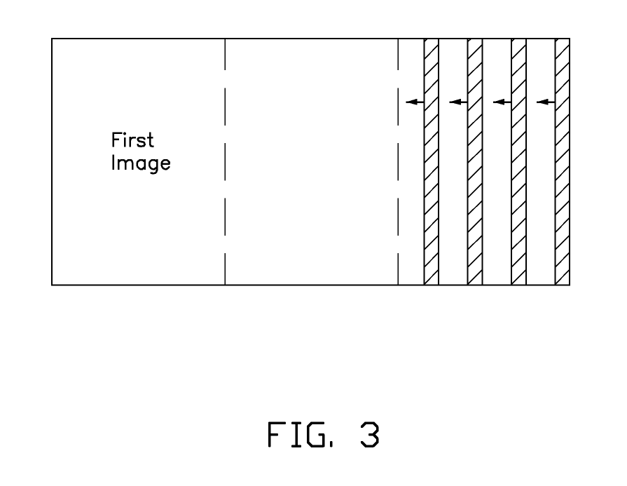

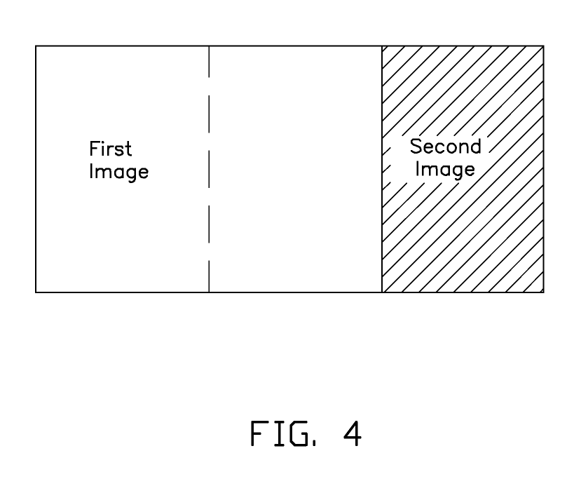

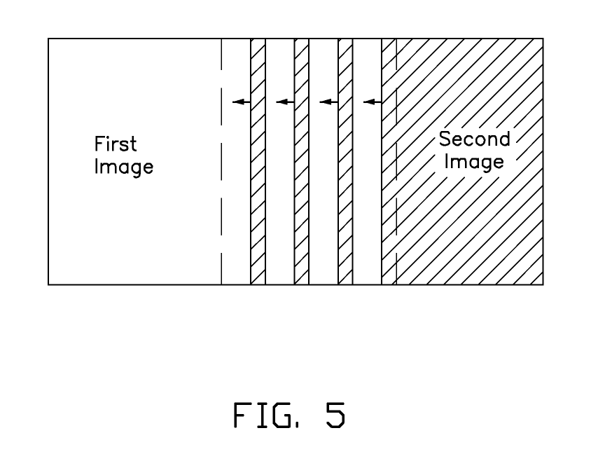

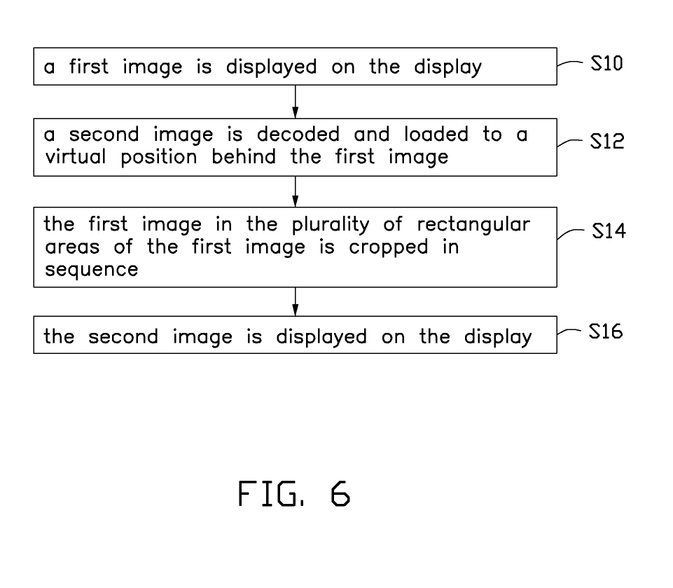

Referring to FIG. 2 to FIG. 5, each rectangular area is further divided into a plurality of parallel bars. Each of the parallel bars fades out along the direction from the first edge to the second edge. Each of the parallel bars may have same size. Each of the parallel bars in a rectangular area may fade to transparency at the same time, and then the next rectangular area is cropped.

The configuration module can be operated by a user to define a number of the plurality of rectangular areas and define a number of the plurality of parallel bars to personalize the special transitioning effects. The process module calculates a width of each of the plurality of rectangular areas and the parallel bars according to the defined number of the rectangular areas and the parallel bars.

As seen in FIG. 2 through FIG. 5, the second image is gradually revealed on the display as the first image is cropped.

Referring to FIG. 6, one embodiment of a method of switching images displayed on an electronic device includes the following blocks.

In block S10, a first image is displayed on the display.

In block S12, a second image is decoded and loaded to a virtual position behind the first image.

In block S14, when it is time to transition from one image to another, the first image is divided into a predetermined number of rectangular areas according to user commands and the rectangular areas are cropped in sequence along a direction from the first edge to the second edge. Each of the plurality of rectangular areas of the first image fades to transparency. If each rectangular area has been further divided into a predetermined number of parallel bars according to user commands, each of the plurality of parallel bars fades to transparency along the direction from the first edge to the second edge revealing the second image.

In block S16, the second image is displayed on the display.

It should be understood the foregoing is merely an example of one special transitioning effect. The number and shape of areas the first image is divided into, and the timing of the transition can be varied. Further, it should be noted that the first image may actually includes more than one image, such as a montage, and the second image may also be other than a single image.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method of displaying images on an electronic device, the method comprising:
displaying a first image on a display, wherein the first image has a first edge and a second edge opposite to the first edge;
decoding a second image and loading the second image to a virtual position behind the first image;
dividing the first image into a plurality of rectangular areas;
cropping the first image in the plurality of rectangular areas in sequence along a direction from the first edge to the second edge, wherein each of the plurality of rectangular areas fades to transparency; and
showing the second image on the display.

2. The method of claim 1, wherein each of the plurality of rectangular areas has same size.

3. The method of claim 1, wherein a number of the plurality of rectangular areas is configured by a configuration module.

4. The method of claim 1, wherein each of the plurality of rectangular areas is divided into a plurality of parallel bars, and each of the plurality of parallel bars fades to transparency along the direction from the first edge to the second edge.

5. The method of claim 4, wherein each of the plurality of parallel bars has same size.

6. The method of claim 4, wherein each of the plurality of parallel bars fades to transparency at the same time.

7. The method of claim 4, wherein a number of the plurality of parallel bars is configured by a configuration module.

8. An electronic device comprising:
a display configured to display a first image;
a decode module configured to decode a second image and load the second image to a virtual position behind the first image, wherein the first image has a first edge and a second edge opposite to the first edge; and
a process module configured to divide the first image into a plurality of rectangular areas and crop the first image in the plurality of rectangular areas in sequence along a direction from the first edge to the second edge, wherein the process module is configured to cause the plurality of rectangular areas to fade to transparency.

9. The electronic device of claim 8, wherein each of the plurality of rectangular areas has same size.

10. The electronic device of claim 8 further comprising a configuration module, wherein a number of the plurality of rectangular areas is defined by the configuration module.

11. The electronic device of claim 8, wherein each of the plurality of rectangular areas is divided into a plurality of parallel bars, and the process module is configured to cause the plurality of parallel bars to fade into transparency along the direction from the first edge to the second edge.

12. The electronic device of claim 11, wherein each of the plurality of parallel bars has same size.

13. The electronic device of claim 11, wherein the process module is configured to cause the plurality of parallel bars to fade to transparency at the same time.

14. The electronic device of claim 11 further comprising a configuration module, wherein a number of the plurality of parallel bars is defined by the configuration module.

15. A method of displaying images on an electronic device, the method comprising:
providing a display configured to display a first image; a decode module configured to decode a second image and load the second image to a virtual position behind the first image, wherein the first image has a first edge and a second edge opposite to the first edge; and a process module configured to divide the first image into a plurality of rectangular areas and crop the first image in the plurality of rectangular areas in sequence along a direction from the first edge to the second edge, wherein the process module is configured to cause the plurality of rectangular areas to fade to transparency;
displaying the first image on a display;
decoding the second image and loading the second image to the virtual position behind the first image;
dividing the first image into the plurality of rectangular areas;
cropping the first image in the plurality of rectangular areas in sequence along the direction from the first edge to the second edge; and
showing the second image on the display.
